(19) United States
(12) Patent Application Publication
(10) Pub. No.: US 2015/0001949 A1
(43) Pub. Date: Jan. 1, 2015

(54) HYBRID CHARGING METHOD FOR WIRELESS POWER TRANSMISSION BASED ON POCKET-FORMING

(71) Applicant: DvineWave Inc., San Ramon, CA (US)

(72) Inventors: Michael A. Leabman, San Ramon, CA (US); Gregory Scott Brewer, Livermore, CA (US)

(73) Assignee: DvineWave Inc., San Ramon, CA (US)

(21) Appl. No.: 13/932,166

(22) Filed: Jul. 1, 2013

(51) Int. Cl. H02J 7/02; H02J 17/00

(52) U.S. Cl. CPC H02J 7/025; H02J 17/00
USPC 307/104

(57) ABSTRACT

The present disclosure provides a hybrid charging method for wireless power transmission based on pocket-forming. This method may extend the battery life of electronic devices such as tablets, smartphones, Bluetooth headsets, smart-watches among others. The method may include wireless power transmission through suitable techniques such as pocket-forming, while including an additional source of energy (backup battery) in the receiver attached or connected to the electronic device.

### CROSS-REFERENCES TO RELATED APPLICATIONS

The present disclosure is related to U.S. Non-Provisional patent application Ser. Nos. 13/891,430 filed May 10, 2013, entitled “Methodology For Pocket-forming”; 13/891,445 filed May 10, 2013, entitled “Transmitters For Wireless Power Transmission”; and 13/925,469 filed Jun. 24, 2013, entitled “Methodology for Multiple Pocket-Forming” the entire contents of which are incorporated herein by these references.

### FIELD OF INVENTION

The present disclosure relates to wireless power transmission, and more particularly to a hybrid charging method for wireless power transmission based on pocket-forming.

### BACKGROUND OF THE INVENTION

Portable electronic devices such as smart phones, tablets, notebooks and others, have become an everyday need in the way we communicate and interact with others. The frequent use of these devices may require a significant amount of power, which may easily deplete the batteries attached to these devices. Therefore, a user is frequently needed to plug in the device to a power source, and recharge such device. This may be inconvenient and troublesome if the user forgets to plug in or otherwise charge a device, the device may run out of power and be of no use to the user until the user is again able to charge the device.

Wireless power transmission may be an answer for the situation described above, however wireless power transmission may usually need a transmitter and a receiver to work. There may be situations when transmitter, being the source of power, may be out of range with the receiver and hence no wireless power transmission may occur. In some situations carrying out an extra set of batteries may be a solution, however some portable electronic devices may have internal batteries that may not be easily replaced. For the foregoing reasons, there may be a need for increasing the battery life of the aforementioned electronic devices.

### SUMMARY OF THE INVENTION

The present disclosure provides a hybrid charging method for wireless power transmission based on pocket-forming. This method may extend the battery life of electronic devices such as tablets, smartphones, Bluetooth headsets, smart-watches among others running on small batteries. The method may include wireless power transmission through suitable techniques such as pocket-foaming, while including an additional source of energy (backup battery) in the receiver attached or connected to the electronic device.

In an embodiment, an example of wireless power transmission through pocket forming may be provided.

In another embodiment, a schematic view of an electronic device including at least one embedded receiver with an additional feature such as a backup battery, may be provided.

in an even further embodiment, an example where wireless power transmission may occur may be provided. In this example, a tablet device, including an embedded or connected receiver with a backup battery, may be charged.

In another embodiment, an example where wireless power transmission may not occur may be provided. In this example, a tablet device, including an embedded or connected receiver with a backup battery, may be out of range with a transmitter and hence no wireless power transmission may occur. However, the tablet device, when running out of power, may use an alternative source of power such as the backup battery included in the embedded receiver.

The method here disclosed may provide wireless power to electronic devices such as tablets, smartphones and the like. As described in embodiments above, such devices may include an additional source of power such as a backup battery which may be included in the receiver attached to them, which upon discharge may power fully and/or partially the aforementioned devices. The foregoing method may decrease fully and/or partially power loads on a device's battery. Thus, battery life in such devices may be enhanced.

### BRIEF DESCRIPTION OF THE DRAWINGS

Embodiments of the present disclosure are described by way of example with reference to the accompanying figures, which are schematic and may not be drawn to scale. Unless indicated as representing prior art, the figures represent aspects of the present disclosure. The main features and advantages of the present disclosure will be better understood with the following descriptions, claims, and drawings, where:

FIG. 1 illustrates a wireless power transmission example situation using pocket-forming, according to an embodiment.

FIG. 2 illustrates prior art powering of an electronic device.

FIG. 3 illustrates an electronic device including at least one embedded which may contain a backup battery, according to an embodiment.

FIG. 4A illustrates a wireless power transmission within a room in accordance with the invention of FIG. 1.

FIG. 4B illustrates no wireless power transmission taking place outdoors with an electronic device out of transmitter range in accordance with the invention of FIG. 1.

### DETAILED DESCRIPTION OF THE DRAWINGS

### Definitions

“Pocket-forming” may refer to generating two or more RF waves which converge in 3-d space, forming controlled constructive and destructive interference patterns.

“Pockets of energy” may refer to areas or regions of space where energy or power may accumulate in the form of constructive interference patterns of RF waves.

“Null-space” may refer to areas or regions of space where pockets of energy do not form because of destructive interference patterns of RF waves.

“Transmitter” may refer to a device, including a chip which may generate two or more RF signals, at least one RF signal being phase shifted and gain adjusted with respect to other RF signals, substantially all of which pass through one or more RP antenna such that focused RF signals are directed to a target.

“Receiver” may refer to a device including at least one antenna element, at least one rectifying circuit and at least one power converter, which may utilize pockets of energy for powering, or charging an electronic device.

“Adaptive pocket-forming” may refer to dynamically adjusting pocket-forming to regulate power on one or more targeted receivers.

### DESCRIPTION OF THE DRAWINGS

In the following detailed description, reference is made to the accompanying drawings, which form a part hereof. In the drawings, which may not be to scale or to proportion, similar symbols typically identify similar components, unless context dictates otherwise. The illustrative embodiments described in the detailed description, drawings and claims, are not meant to be limiting. Other embodiments may be used and/or and other changes may be made without departing from the spirit or scope of the present disclosure.

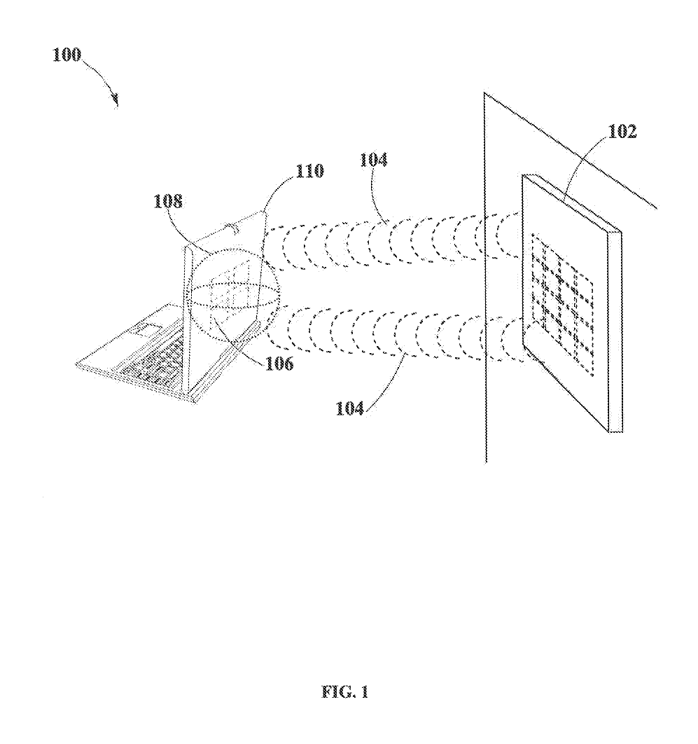

FIG. 1 illustrates wireless power transmission 100 using pocket-forming. A transmitter 102 may transmit controlled Radio RF waves 104 which may converge in 3-d space. These Radio frequencies (RF) waves 104 may be controlled through phase and/or relative amplitude adjustments to form constructive and destructive interference patterns (pocket-forming), Pockets of energy 108 may be formed at constructive interference patterns and can be 3-dimensional in shape whereas null-spaces may be generated at destructive interference patterns. A receiver 106 may then utilize pockets of energy 108 produced by pocket-forming for charging or powering an electronic device, for example a laptop computer 110 and thus effectively providing wireless power transmission. In other situations there can be multiple transmitters 102 and/or multiple receivers 106 for powering various electronic equipment for example smartphones, tablets, music players, toys and others at the same time. In other embodiments, adaptive pocket-forming may be used to regulate power on electronic devices.

In an embodiment, transmitter 102 may include a housing where at least two or more antenna elements, at least one RF integrated circuit (RFIC), at least one digital signal processor (DSP) or micro-controller, and one communications component may be included. Transmitter 102 may also include a local oscillator chip for converting alternating current (AC) power to analog RF signals. Such RF signals may firstly be phase and gain adjusted through an RFIC proprietary chip, and then converted to RF waves via antenna elements. On the other hand, receiver 106 may include a housing where at least one antenna element, at least one rectifier and at least one power converter may be included. Receiver 106 may communicate with transmitter 102 through short RF waves or pilot signals sent through antenna elements. In some embodiments, receiver 106 may include an optional communications device for communicating on standard wireless communication protocols such as Bluetooth, Wi-Fi or Zigbee with transmitter 102. In some embodiments, receiver 106 may be implemented externally to electronic devices in the form of cases, e.g. camera cases, phone cases and the like which may connect through suitable and well known in the art techniques such as universal serial bus (USB). In other embodiments, receiver 106 may be embedded within electronic devices.

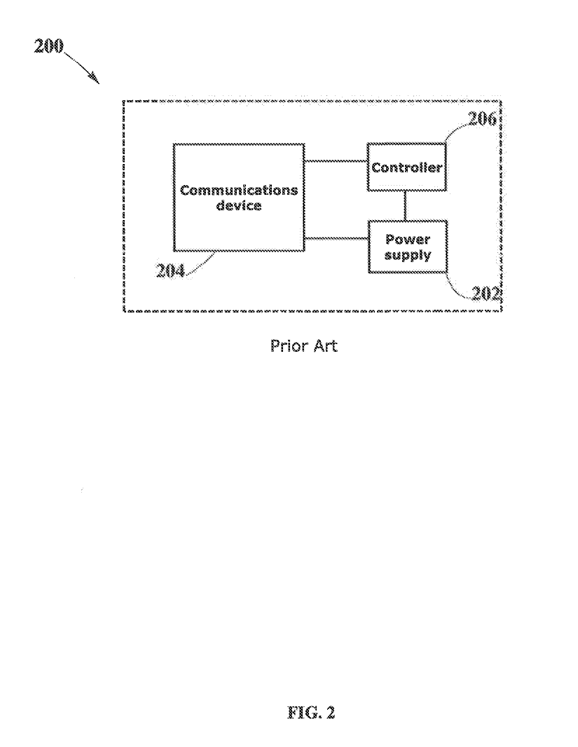

FIG. 2 illustrates prior art powering of an electronic device 200. Electronic device 200 may require a power supply 202 for powering its various components, for example a communications device 204 for wireless communication, a micro-controller 206 for function control, among other components not shown in FIG. 2. In an embodiment, electronic device 200 may represent a tablet running on power supply 202 in the form of a Lithium-ion battery or any of the like.

Power supply 202 may be the only power source on which electronic device 200 may run. Thus, when power supply 202 runs out, electronic device 200 may be unusable. The foregoing situation may be unpleasant to users who may depend heavily on their electronic devices and may therefore be forced to carry extra power supplies 202 in the form of batteries for example. In addition, if electronic device 200 does not allow for charging or replacing power supply 202, electronic device 200 may be inoperable, and thus, may turn into unnecessary waste.

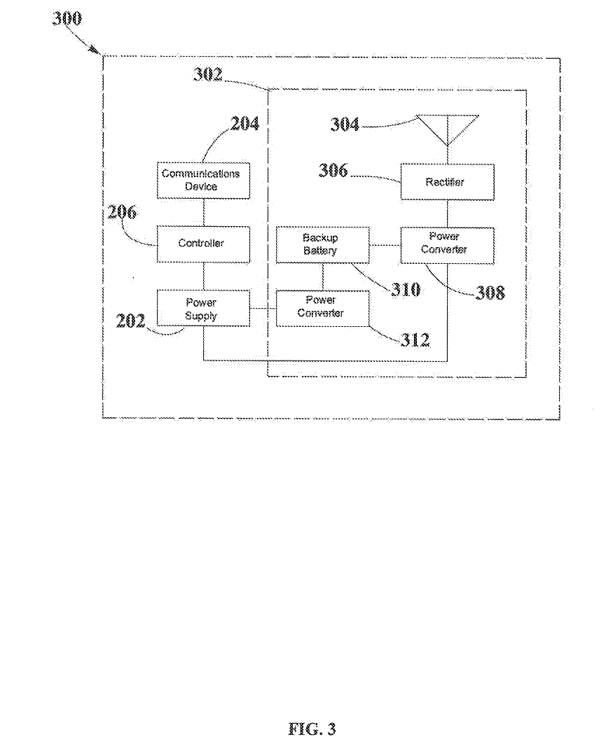

FIG. 3 illustrates an electronic device 300, similar to electronic device 200 described in FIG. 2. Electronic device 300 may include at least one embedded receiver 302, that may have a backup battery 310 as an additional feature compared to the one described in FIG. 1. Embedded receiver 302, may also include a subset of antenna elements 304 for converting pockets of energy, produced through pocket-forming, into AC voltage, at least one rectifier 306 where AC voltage may he converted to direct current (DC) voltage, and at least one power converter 308 for providing constant DC voltage output to either a backup battery 310 or to power supply 202.

In this embodiment, backup battery 310 may be an additional source of energy for electronic device 300 and may be any suitable battery that provides enough voltage to power or Charge electronic device 300. Backup battery 310 may also require a power converter 312 to deliver DC voltage to power supply 202. Backup battery 310 may be charged while embedded receiver 302 is capturing pockets of energy from the transmitter to which is connected. In other embodiments, power converter 308 may pass DC voltage directly to power supply 202 without charging backup battery 310. In yet another embodiment power converter 308 may pass DC voltage to both power supply 202 and backup battery 310 at the same time. Power supply 202 may constantly provide DC voltage to micro-controller 206 and communications device 204 as long as it does not run out of charge or power from embedded receiver 302.

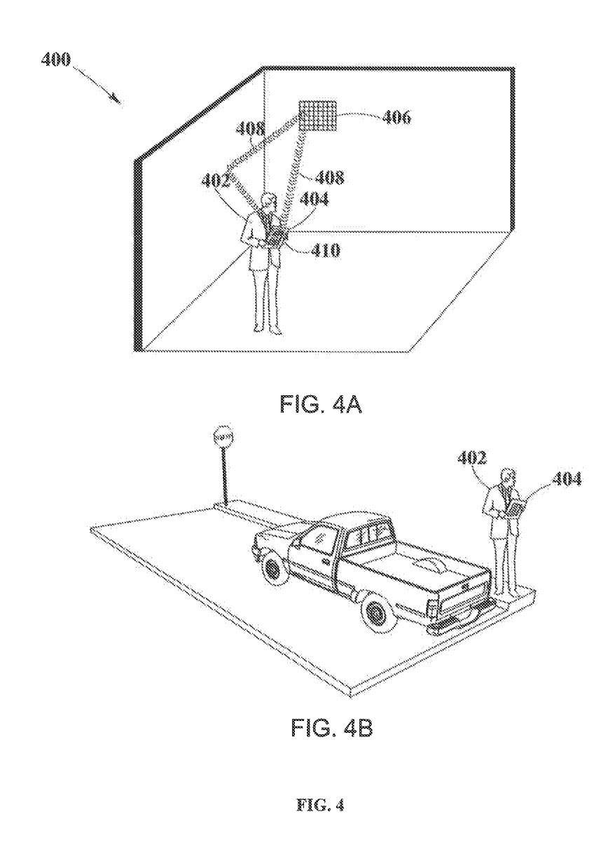

FIG. 4A and FIG. 4B illustrate two embodiments where wireless power transmission 400 may or may not occur. In FIG. 4A, an user 402 may be inside a room and may hold on his hands an electronic device, which in this case, may be a tablet 404. Tablet 404 may include a receiver (not shown) either embedded to it or as a separate adapter connected to tablet 404. The receiver embedded or connected to tablet 404 may be as the one described in FIG. 3, hence including an additional feature such as a backup battery (not shown). The backup battery included in the receiver may be fully or partially charged while wireless power transmission takes place. FIG. 4A also shows a transmitter 406, as the one described in FIG. 1. Transmitter 406 may transmit controlled Radio RF waves 408 which may converge in 3-d space and deliver pockets of energy 410 to the receiver. In this embodiment, the receiver may either power tablet 404 directly or charge backup battery first and then power tablet 404.

FIG. 4B shows an example where wireless power transmission may not occur. In this embodiment, user 402 may be found outdoors walking down the sidewalk where transmitter 406 may not be available, and hence no wireless power transmission may occur. However, tablet 404 may still have an extra source of power (backup battery 310) included as an internal part of the receiver. As described in FIG. 4A, backup battery 310 may have been charged while transmitter 406 was available. Tablet 404 may then use the available power from the backup battery 310 in the receiver when power supply 202 (tablet 404's battery) runs out. Thus, power supply 202 life can be greatly increased.

While various aspects and embodiments have been disclosed herein, other aspects and embodiments are contemplated. The various aspects and embodiments disclosed herein are for purposes of illustration and are not intended to be limiting, with the true scope and spirit being indicated by the following claims.

Having thus described the invention, I claim:

1. A hybrid charging method for wireless transmission of power to a portable electronic device, comprising:
connecting a hybrid receiver to an internal power source and a backup battery;
receiving pockets of energy comprised of power RF signals at receiver antenna elements to produce an AC voltage from a RF circuit connected to a transmitter;
rectifying the AC voltage to a direct current voltage;
converting the direct current voltage to a constant direct current voltage output; and;
providing the constant direct current voltage output to power either or both the backup battery and the internal power source of the hybrid receiver.

2. The hybrid charging method for wireless transmission of power to a portable electronic device of claim 1, wherein the hybrid receiver is embedded in the portable electronic device.

3. The hybrid charging method for wireless transmission of power to a portable electronic device of claim 1, wherein the internal power source of the receiver is a rechargeable or disposable battery.

4. The hybrid charging method for wireless transmission of power to a portable electronic device of claim 1, wherein the hybrid receiver and transmitter each include a controller connected to a communication device for communications between the hybrid receiver and the transmitter to control the power received by the backup battery or the internal power source.

5. The hybrid charging method for wireless transmission of power to a portable electronic device of claim 4, further comprising the step of communicating between the receiver and transmitter through short RF waves or pilot signals on standard wireless communication protocols including Bluetooth, Wi-Fi or Zigbee with backup battery and internal power source status information to control the power delivered to the battery or the internal power source.

6. The hybrid charging method for wireless transmission of power to a portable electronic device of claim 1, wherein the converting step includes a power converter for charging either or both the backup battery and the internal power source.

7. The hybrid charging method for wireless transmission of power to a portable electronic device of claim 6, wherein the power converter is directly connected to the backup battery and to the internal power source of the hybrid receiver.

8. The hybrid charging method for wireless transmission of power to a portable electronic device of claim 1, wherein the converting step includes a power converter connected between the backup battery and the internal power source.

9. The hybrid charging method for wireless transmission of power to a portable electronic device of claim 1, wherein the backup battery is connected to the internal power source of the receiver.

10. The hybrid charging method for wireless transmission of power to a portable electronic device of claim 1, further including the step of implementing externally the connection of the hybrid receiver to the portable electronic device in the configuration of a case and further including the step of connecting the case to the electronic device through an universal serial bus or electrical plug.

11. The hybrid charging method for wireless transmission of power to a portable electronic device of claim 1, wherein the internal power source is a rechargeable Lithium-ion battery and the hybrid receiver and transmitter controllers are a digital signal processor, a microprocessor or an ASIC.

12. The hybrid charging method for wireless transmission of power to a portable electronic device of claim 5, further comprising the step of transmitting simultaneously both Wi-Fi signals and power RF signals from the transmitter to the receiver.

13. A hybrid charging method for wireless transmission of power to a portable electronic device, comprising:
supplying RF power signals to a hybrid receiver including antenna elements, a digital signal processor (DSP), a rectifier, a power converter, a backup battery, a power supply and a communications device;
generating the RF power signals through a RF integrated chip controlled by a DSP in a transmitter with a communication device controlled by the DSP;
communicating the power status of the backup battery and power supply of the receiver to the transmitter through the transmitter and receiver communication devices on short RF signals with standard wireless communication protocols;
transmitting the power RF signals to the antenna elements of the hybrid for rectifying the AC voltage at the antenna elements into a direct current voltage and converting the direct current voltage into a constant direct current voltage for powering the backup battery and the power source of the receiver.

14. The hybrid charging method for wireless transmission of power to a portable electronic device of claim 13, further comprising:
decoding the short RF signals to identify the gain and phase of the receiver to determine the direction of the receiver;
transmitting pockets of energy consisting of power RF signals from the transmitter through the at least two RF antennas in the transmitter to the antenna elements of the receiver; and
running continuously the portable electronic device with either the power source or the backup battery while charging either the backup battery or the power source to provide an inexhaustible source of operating power for the electronic device.

15. The hybrid charging method for wireless transmission of power to a portable electronic device of claim 13, wherein the RF power signals are comprised of pockets of energy created by pocket-forming techniques.

16. The hybrid charging method for wireless transmission of power to a portable electronic device of claim 13, wherein the power converter of the hybrid receiver is connected to the power source and to the backup battery for maintaining the power levels for charging the power source and backup battery for continuous use without total loss of power during continuous operation of the electronic device.

17. The hybrid charging method for wireless transmission of power to a portable electronic device of claim 13, wherein the power converter of the hybrid receiver includes two power converters, one connected to the backup battery and the power source and the other connected between the backup battery and the power source to regulate the constant direct current voltage to operate the portable electronic device.

18. The hybrid charging method for wireless transmission of power to a portable electronic device of claim 13, further comprising the steps of rectifying the power RF signals defining pockets of energy and converting the rectified power RF signals into a constant DC voltage for charging or powering the portable electronic device.

19. The hybrid charging method for wireless transmission of power to a portable electronic device of claim 13, further comprising the step of powering simultaneously the backup battery and the power source from the power converter.

20. The hybrid charging method for wireless transmission of power to a portable electronic device of claim 13, wherein the hybrid receiver communicates with the transmitter through short RF waves or pilot signals on standard wireless communication protocols including Bluetooth, Wi-Fi or Zigbee with backup battery and internal power source status information to control the power delivered to the battery or the internal power source.

21. The hybrid charging method for wireless transmission of power to a portable electronic device of claim 13, wherein the hybrid receiver communicates power status of the backup battery and power source to the transmitter and the transmitter DSP through a RF integrated circuit controls the phases and amplitudes of the power RF signals in each transmitter antenna in order to generate the desire pocket-forming to power the backup battery and power source.

22. A hybrid receiver for wireless transmission of power to a portable electronic device, comprising:
an antenna for receiving pockets of energy formed from constructive interference patterns of RF waves from a transmitter and for transforming the pockets of energy into AC voltage;
a rectifier connected to the antenna for converting the AC Voltage into DC voltage;
a power converter for changing the DC voltage into a constant DC voltage;
a power source within the portable electronic device connected to the power converter for receiving the constant DC voltage to power or charge the power source; and
a backup battery connected to the power converter for receiving the constant DC voltage to power or charge the backup battery.

23. The hybrid receiver for wireless transmission of power to a portable electronic device of claim 22, wherein the hybrid receiver communicates with the transmitter through short RF waves or pilot signals sent through the antenna.

24. The hybrid charging method for wireless transmission of power to a portable electronic device of claim 22, wherein the power source is a chargeable lithium battery.

25. The hybrid receiver for wireless transmission of power to a portable electronic device of claim 22, wherein the hybrid receiver is embedded in the portable electronic device.

26. The hybrid receiver for wireless transmission of power to a portable electronic device of claim 22, wherein the power converter powers the electronic device directly or charges the backup battery first and then powers the electronic device.
